(19) United States
(12) Patent Application Publication
(10) Pub. No.: US 2003/0017908 A1
(43) Pub. Date: Jan. 23, 2003

(54) Toroidal-type continuously variable transmission

(75) Inventors: Nobuo Goto, Kanagawa (JP); Tomomi Yamaguchi, Kanagawa (JP)

Correspondence Address: SUGHRUE MION, PLLC, 2100 PENNSYLVANIA AVENUE, N.W., WASHINGTON, DC, 20037, US

(73) Assignee: NSK LTD.

(21) Appl. No.: 10/197,572

(22) Filed: Jul. 18, 2002

(30) Foreign Application Priority Data
Jul. 19, 2001 (JP) P. 2001-219077

(51) Int. Cl. F16H 15/38

(52) U.S. Cl. 476/40

(57) ABSTRACT

A trunnion and a rod attached to the present trunnion are formed of single blank material into an integral body. This structure can reduce the number of steps necessary in working operations and assembling operations for the respective composing parts of the toroidal-type continuously variable transmission and also can enhance the dimensional accuracy of the respective composing parts.

### BACKGROUND OF THE INVENTION

The present invention relates to a toroidal-type continuously variable transmission used as a transmission unit forming an automatic transmission apparatus for a vehicle or a transmission for controlling the operating speed of various kinds of industrial machines such as a pump.

It has been studied to use, as a transmission for a vehicle, such a toroidal-type continuously variable transmission as schematically shown in FIGS. 4 and 5, while such toroidal-type continuously variable transmission is in enforcement in a part of the automatic vehicle transmission apparatus and industrial machines. In the toroidal-type continuously variable transmission of this type, for example, as disclosed in JP-UM-A-62-71465, an input side disk 2 is supported concentrically with an input shaft 1 and an output side disk 4 is fixed to the end portion of an output shaft 3 which is disposed concentric with the input shaft 1. Inside a casing (see FIG. 7 which will be discussed later) 5 in which the toroidal-type continuously variable transmission is stored, there are disposed trunnions 7, 7 which swings about their respective pivot shafts 6, 6 situated at twisted positions with respect to the input shaft 1 and output shaft 3.

The pivot shafts 6, 6 are disposed by a pair on the outer surfaces of the two end portions of each of the trunnions 7, 7 so as to be concentric with each other. The center axes of the pivot shafts 6, 6 do not intersect with the center axes of the input side and output side disks 2, 4 but they are present at twisted positions existing in a direction almost at right angles to the axial directions of the disks 2, 4. Also, the inclination angles of the displacement shafts 8, 8 can be adjusted by the base half portions of displacement shafts 8, 8 supported on the central portions of the respective trunnions 7, 7, and swinging the trunnions 7, 7 about their respective pivot shafts 6, 6. In the peripheries of the front half portions of the displacement shafts 8, 8 respectively supported on their associated trunnions 7, 7, power rollers 9, 9 are supported so as to be rotated. And, the power rollers 9, 9 are held by and between the inner surfaces 2a, 4a of the input side and output side disks 2, 4.

The sections of the mutually opposed inner surfaces 2a, 4a of the input side and output side disks 2, 4 are each formed as an arc which has the pivot shaft 6 as a center thereof, or an arc-shaped concave surface which can be obtained by rotating a curved line approximate to such arc. And, the peripheral surfaces 9a, 9a of the power rollers 9, 9, which are formed as spherically convex surfaces, are contacted with the inner surfaces 2a, 4a of the input side and output side disks 2, 4. Also, between the input shaft 1 and input side disk 2, there is interposed a loading cam device 10; and, the input side disk 2 can be driven or rotated by the loading cam device 10, while pushing it elastically toward the output side disk 4.

When the above structured toroidal-type continuously variable transmission is in use, with the rotation of the input shaft 1, the loading cam device 10 rotates the input side disk 2 while pressing the input side disk 2 against the plurality of power rollers 9, 9. And, the rotational movement of the input side disk 2 is transmitted to the output side disk 4 through the plurality of power rollers 9, 9, thereby rotating the output shaft 3 fixed to the output side disk 4.

To change the rotation speed between the input shaft 1 and output shaft 3, firstly, to reduce the rotation speed between the input shaft 1 and output shaft 3, the trunnions 7, 7 may be respectively swung about their associated pivot shafts 6, 6 to thereby incline the displacement shafts 8, 8 in such a manner that the peripheral surfaces 9a, 9a of the power rollers 9, 9, as shown in FIG. 4, can be respectively contacted with the near-center portion of the inner surface 2a of the input side disk 2 and the near-outer-periphery portion of the inner surface 4a of the output side disk 4.

On the other hand, to increase the rotation speed between the input shaft 1 and output shaft 3, the trunnions 7, 7 may be respectively swung to thereby incline the displacement shafts 8, 8 in such a manner that the peripheral surfaces 9a, 9a of the power rollers 9, 9, as shown in FIG. 5, can be respectively contacted with the near-outer-periphery portion of the inner surface 2a of the input side disk 2 and the near-center portion of the inner surface 4a of the output side disk 4. In case where the inclination angles of these displacement shafts 8, 8 are set intermediate between FIGS. 4 and 5, there can be obtained an intermediate transmission ratio between the input shaft 1 and output shaft 3.

Further, FIGS. 6 and 7 show a toroidal-type continuously variable transmission disclosed in JP-UM-A-1-173552 and specified more than the above conventional one. In this toroidal-type continuously variable transmission, an input side disk 2 and an output side disk 4 are rotatably supported on the periphery of a circular-pipe-shaped input shaft 11, respectively. Also, between the end portion of the input shaft 11 and input side disk 2, a loading cam device 10 is interposed. On the other hand, an output gear 12 is connected to the input side disk 4, while the output side disk 4 and output gear 12 can be rotated synchronously with each other.

Pivot shafts 6, 6, which are concentrically disposed on the two end portions of a pair of trunnions 7, 7, are supported on a pair of support plates 13, 13 so as to be swung and shifted in the axial direction thereof (in FIG. 6, in the front and rear direction; and, in FIG. 7, in the vertical direction). And, the base half portions of displacement shafts 8, 8 are supported on the middle portions of the respective trunnions 7, 7. The displacement shafts 8, 8 are structured such that their base half portions and their front half portions are formed eccentrically to each other. And, the base half portions of the displacement shafts 8, 8 are rotatably supported on the middle portions of the respective trunnions 7, 7, while power rollers 9, 9 are rotatably supported on the front half portions of the respective trunnions 7, 7, respectively.

By the way, the above-mentioned pair of displacement shafts 8, 8 are disposed at the 180° opposite positions with respect to the input shaft 11. The direction, in which the base half portions and front half portions of the respective displacement shaft 8, 8 are eccentric to each other, is set in the same direction (in FIG. 7, in the vertically reversed direction) with respect to the rotational direction of the input side and output side disks 2, 4. Also, the eccentric direction is set in a direction which intersects almost at right angles to the arrangement direction of the input shaft 11. Therefore, the power rollers 9, 9 are supported so as to be able to shift slightly with respect to the arrangement direction of the input shaft 11.

Also, between the outer surfaces of the respective power rollers 9, 9 and the inner surfaces of the middle portions of the respective trunnions 7, 7, there are interposed thrust ball bearings 14, 14 and thrust needle roller bearings 15, 15 in the order starting from the outer surfaces of the respective power rollers 9, 9. The thrust ball bearings 14, 14, while supporting thrust-direction loads applied to the power rollers 9, 9, allow the power rollers 9, 9 to rotate. Also, the thrust needle roller bearings 15, 15, while supporting thrust loads applied to outer races 16, 16 forming the thrust ball bearings 14, 14 from the power rollers 9, 9, allow the front half portions of the respective displacement shaft 8, 8 and the present outer races 16, 16 to swing about the base half portions of the respective displacement shaft 8, 8. Further, the respective trunnions 7, 7 can be shifted in the axial directions of the respective pivot shafts 6, 6 by their associated actuators 17, 17 each of an oil pressure type.

Therefore, as shown in FIGS. 7 and 8, the base end portions (in FIGS. 7 and 8, the upper end portions) of rods 18, 18 are connected and fixed to the one-end portions (in FIGS. 7 and 8, the lower end portions) of the respective trunnions 7, 7; and, to the middle portions of the respective rods 18, 18, there are fixed pistons 19, 19 respectively. And, the pistons 19, 19 are respectively fitted and mounted into the interior portions of their associated cylinders 20, 20 to thereby form the above-mentioned respective actuators 17, 17. By the way, the base end portions of the rods 18, 18 are respectively fitted into their associated connecting holes 21, 21 respectively formed in the pivot shafts 6, 6 situated on the one-end portions of the respective trunnions 7, 7, while pins 22, 22 are disposed so as to prevent the rods 18 base end portions from slipping out of the connecting holes 21, 21. For insertion of the pins 22, 22, in the one-end portions of the respective trunnions 7, 7 and also in the base end portions of the respective rods 18, 18, there are formed pin holes 23a, 23a respectively. Thanks to this structure, correspondingly as pressure oil is supplied to and discharged from the respective cylinders 20, 20, the respective trunnions 7, 7 can be driven or shifted in the axial directions of their associated pivot shafts 6, 6. At the same time, in the power transmission, the loads in the axial directions of their associated pivot shafts 6, 6 applied from the power rollers 9, 9 to the trunnions 7, 7 can be supported.

In the case of the above-structured toroidal-type continuously variable transmission, the rotational movement of the input shaft 11 is transmitted to the input side disk 2 through the loading cam device 10. And, the rotational movement of the input side disk 2 is then transmitted to the output side disk 4 through the pair of power rollers 9, 9 and further the rotational movement of the output side disk 4 is taken out by the output gear 12.

To change the rotation speed ratio between the input shaft 11 and output gear 12, the pair of trunnions 7, 7 may be shifted by the actuators 17, 17 in their mutually opposite directions; for example, in FIG. 7, the power roller 9 situated on the right may be shifted in the upward direction, whereas the power roller 9 situated on the left may be shifted in the downward direction. This changes the directions of the tangential-direction forces acting on the mutual contact portions between the peripheral surfaces 9a, 9a of the power rollers 9, 9 and the inner surfaces 2a, 4a of the input side and output side disks 2, 4. And, with such change in the directions of the tangential-direction forces, the trunnions 7, 7 are swung in the mutually reversed directions about the pivot shafts 6, 6 which are pivotally supported on their associated support plates 13, 13. This changes the mutual contact positions between the peripheral surfaces 9a, 9a of the power rollers 9, 9 and the inner surfaces 2a, 4a of the input side and output side disks 2, 4, as shown in the above-described FIGS. 4 and 5, with the result that the rotation speed ratio between input shaft 11 and output gear 12 is caused to vary.

When the power is transmitted by the above-structured toroidal-type continuously variable transmission, in accordance with the elastic deformation of the respective composing parts thereof, the power rollers 9, 9 are shifted in the axial direction of the input shaft 11. And, the displacement shafts 8, 8 respectively supporting these power rollers 9, 9 are slightly rotated about their respective base half portions. As a result of this slight rotation, the outer surfaces of the outer races 16, 16 of the thrust ball bearings 14, 14 and the inner surfaces of the trunnions 7, 7 are shifted with respect to each other. This relative shift requires only a small force, because the thrust needle roller bearings 15, 15 are interposed between the outer surfaces of the outer races 16, 16 and the inner surfaces of the trunnions 7, 7.

To structure the above-mentioned toroidal-type continuously variable transmission, conventionally, the trunnions 7, 7 and rods 18, 18, which are produced separately from each other, are connected and fixed to each other. This requires various operations: for example, an operation to work the one-end portions of the respective trunnions 7, 7 to thereby form the connecting holes 21, 21; an operation to work the one-end portions of the respective trunnions 7, 7 and the base end portions of the respective rods 18, 18 to thereby form the pin holes 23a, 23b; an operation to insert the rods 18, 18 into their respective connecting holes 21, 21; and, an operation to insert the pins 22, 22 into their respective pin holes 23a, 23b. These operations impede a reduction in the manufacturing cost of the toroidal-type continuously variable transmission.

Also, since the pin holes 23a must be formed, there arises the need to set the thickness T₇ (FIG. 8) of the one-end portions of the respective trunnions 7, 7 larger than the thickness that is originally necessary in the present portions. This makes it difficult to reduce the axial-direction dimensions of the respective trunnions 7, 7, which in turn makes it difficult to reduce the size and weight of the toroidal-type continuously variable transmission.

Further, in the conventional structure, there is a possibility that the center axes of the pivot shafts 6, 6 disposed on the two end portions of the respective trunnions 7, 7 and the center axes of the rods 18, 18 connected and fixed to the one-end portions of the respective trunnions 7, 7 can be shifted from each other due to working errors or assembling errors. And, in case where they are shifted from each other, there is a fear that the transmission operation of the toroidal-type continuously variable transmission can be made unstable. That is, in this case, when the trunnions 7, 7 are swung about their respective pivot shafts 6, 6 in accordance with the transmission operation of the toroidal-type continuously variable transmission, the rods 18, 18 are caused to swing. This can increase a frictional force acting on between the outer peripheral surfaces of the pistons 19, 19 fixed to the middle portions of the rods 18, 18 and the inner peripheral surfaces of the cylinders 20, 20, thereby delaying the swinging shift motion of the present trunnion 7 than the swinging shift motion of the other trunnion 7. This impairs the synchronous stability of the transmission operations of the trunnions 7, 7, thereby making it impossible to execute the smooth transmission operation of the toroidal-type continuously variable transmission.

Moreover, since the plurality of parts are connected together, the distance between the portions of the respective trunnions 7, 7 that support the power rollers 9, 9 and the portions of the rods 18, 18 to which the pistons 19, 19 are fixed, or a precess cam (not shown) disposed on the leading end portion of any one of the rods 18 for detection of the attitudes of the respective trunnions 7, 7 is easy to vary due to manufacturing errors. When the toroidal-type continuously variable transmission is in operation, even in case where the trunnions 7, 7 are respectively shifted in the axial directions of their associated pivot shafts 6, 6 only slightly, the transmission operation is to be started. For this reason, the variations in the above distance are not desirable.

### SUMMARY OF THE INVENTION

The present invention aims at eliminating the drawbacks found in the above-mentioned conventional toroidal-type continuously variable transmission. Accordingly, it is an object of the present invention to provide a toroidal-type continuously variable transmission which allows a reduction in the manufacturing cost thereof, can reduce the size and weight thereof, and can stabilize the transmission operation thereof.

In attaining the above object, according to a first aspect of the present invention, there is provided a toroidal-type continuously variable transmission, comprising: an input side disk; an output side disk disposed concentric with the input side disk; a plurality of trunnions interposed between the input side disk and the output side disk and swingable about pivot shafts situated at twisted positions with respect to the axes of the input side and output side disks; a plurality of displacement shafts disposed on the trunnions one by one so as to project from inner surfaces of respective trunnions; a plurality of power rollers disposed on the trunnions one by one and held between inner surfaces of the input side and output side disks so as to be rotatably supported on respective displacement shafts; a plurality of rods having respective base end portions connected and fixed to one-end portions of the trunnions, the rods being disposed concentric with the pivot shafts of the trunnions; and, a plurality of actuators for shifting the rods in the axial direction thereof, wherein the trunnion and the rod are integrally formed of a single material.

According to a second aspect of the present invention, there is provided a toroidal-type continuously variable transmission as set forth in the first aspect of the present invention, wherein the trunnion and the rod are integrally formed of the single material by forging or by casting.

According to a third aspect of the present invention, there is provided a toroidal-type continuously variable transmission as set forth in the first aspect of the present invention, wherein the trunnion and the rod are produced by finish working an integral body, by cutting the same, after forming the integral body of an iron-system alloy by forging or casting.

According to a fifth aspect of the present invention, there is provided a toroidal-type continuously variable transmission as set forth in the third aspect of the present invention, wherein the finish working includes cutting.

According to a fifth aspect of the present invention, there is provided a toroidal-type continuously variable transmission as set forth in the third aspect of the present invention, wherein the outer peripheral surfaces of the rod and the pivot shafts formed in the one-end portions of the trunnions are worked with the outer peripheral surfaces of the pivot shafts formed in the-other-end portions of the trunnions as the standards.

The above-structured toroidal-type continuously variable transmission according to the present invention is similar to a conventionally known toroidal-type continuously variable transmission shown in the above-described FIGS. 4 to 7 in the basic operations to transmit the power between the input side disk and output side disk and to change the transmission ratio between these two disks.

Especially, in the case of a toroidal-type continuously variable transmission according to the present invention, since each of the trunnions and each of the rods attached to the present trunnion are formed of single blank material into an integral body, the manufacturing cost of the toroidal-type continuously variable transmission can be reduced, the size and weight thereof can be reduced, and the transmission operation thereof can be stabilized.

That is, in the case of the present invention, there are eliminated not only the operation to work the one-end portions of the trunnions to thereby form the connecting holes therein but also the operation to insert the respective rods into their associated connecting holes. Also, there is eliminated the need to work the one-end portions of the trunnions and the base end portions of the rods to thereby form the pin holes therein and, at the same time, there are eliminated the need to dispose the pins and the need to insert the pins into the pin holes. This can facilitate the reduction of the manufacturing cost of the toroidal-type continuously variable transmission.

Also, due to elimination of the need to form the pin holes in the one-end portions of the trunnions, there is eliminated the need to set the thickness of the present portions larger than necessary, which can facilitate the reduction of the size and weight of the toroidal-type continuously variable transmission accordingly.

Further, because the axes of the pivot shafts disposed on the two end portions of the respective trunnions can be easily made to coincide with the axes of the rods disposed on these trunnions, the transmission operation of the toroidal-type continuously variable transmission can be stabilized.

Moreover, variations in the distance between the portions of the trunnions for supporting the power rollers and the remaining portions of the trunnions conventionally occurring due to the manufacturing errors and assembling errors can be made difficult to occur, which also makes it possible to stabilize the transmission operation of the toroidal-type continuously variable transmission.

### BRIEF DESCRIPTION OF THE DRAWINGS

FIG. 1 shows an embodiment of a toroidal-type continuously variable transmission according to the present invention, when a trunnion formed integrally with a rod is viewed from a similar direction to FIG. 7;

FIG. 2 is a side view of a rod formed integrally with a trunnion employed in the above embodiment, showing a state in which a finishing operation is enforced on the rod;

FIG. 3 is a view of the rod and trunnion when they are viewed from the right side of FIG. 2;

FIG. 4 is a side view of the basic structure of a conventional toroidal-type continuously variable transmission, showing its maximum speed reducing state;

FIG. 5 is a side view of the above conventional toroidal-type continuously variable transmission, showing its maximum speed increasing state;

FIG. 6 is a section view of an example of a concrete structure of a conventional toroidal-type continuously variable transmission;

FIG. 7 is a section view taken along the line A-A shown in FIG. 6; and,

FIG. 8 shows a trunnion and a rod incorporated into the conventional structure when they are viewed from a similar direction to FIG. 7.

### DETAILED DESCRIPTION OF THE PREFERRED EMBODIMENT

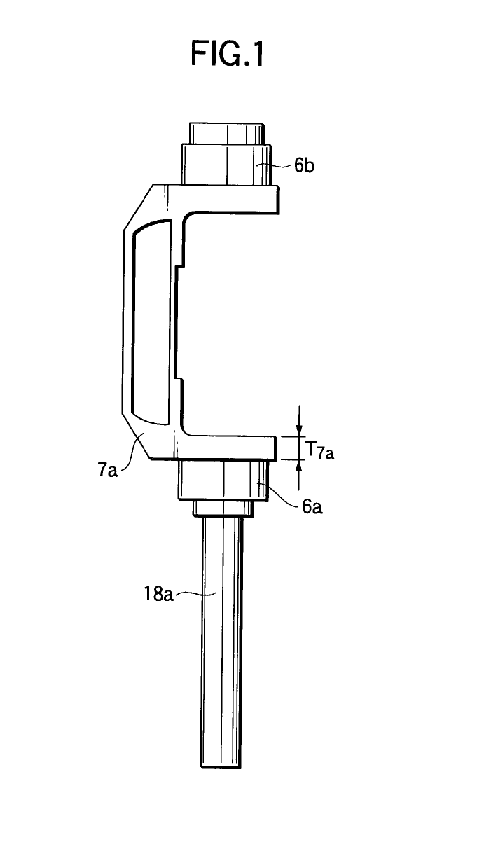

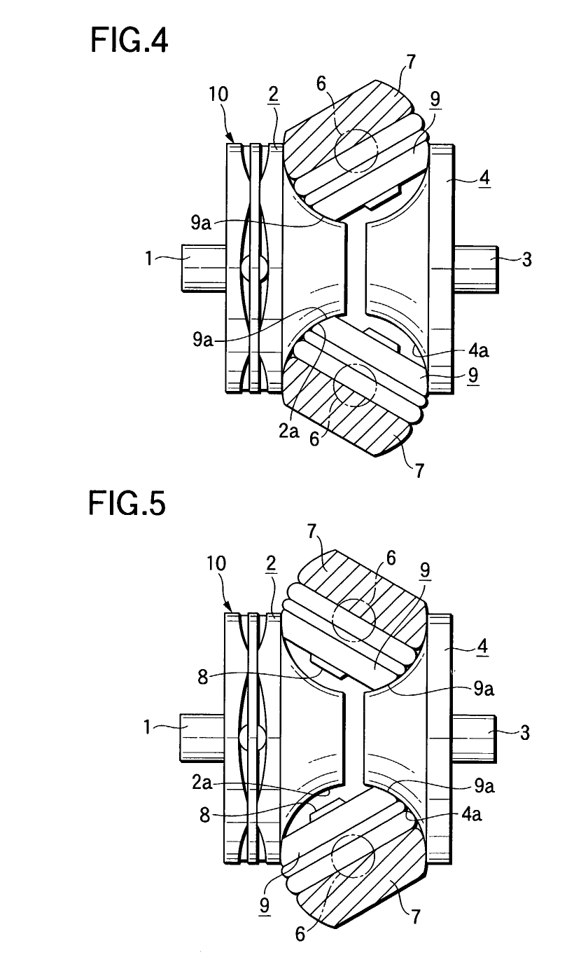

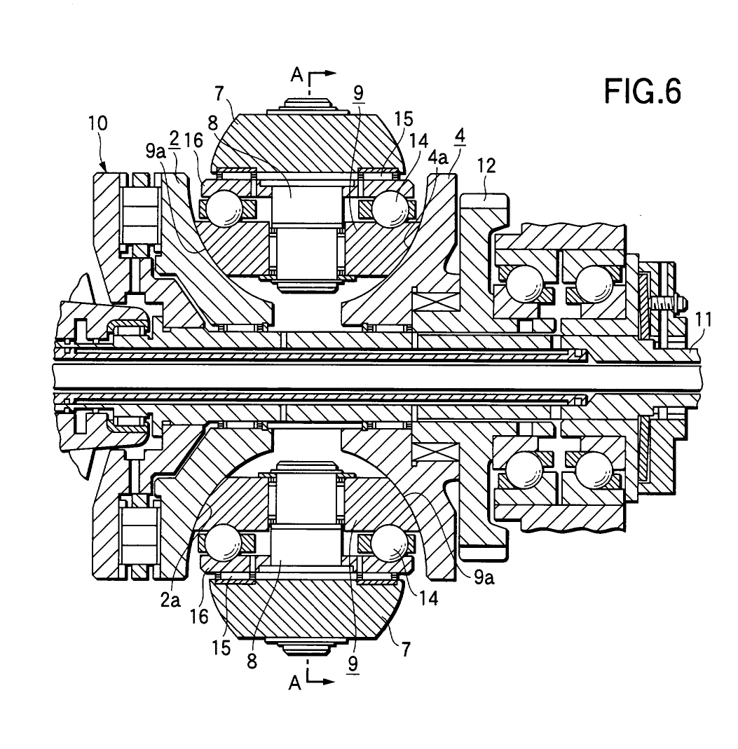

Now, FIGS. 1 to 3 show an embodiment of a structure according to the present invention. By the way, the present invention is characterized in that a trunnion 7a and a rod 18a are formed of single blank material into an integral body to thereby reduce the manufacturing cost, size and weight of the toroidal-type continuously variable transmission as well as stabilize the transmission operation thereof. The structures and operations of the remaining portions of the present invention are similar to a conventionally known toroidal-type continuously variable transmission including the structures shown in FIGS. 4 to 7. Therefore, the illustration and description of the equivalent portions thereof are omitted here and, in the following, description will be given mainly of the characteristic elements of the present invention.

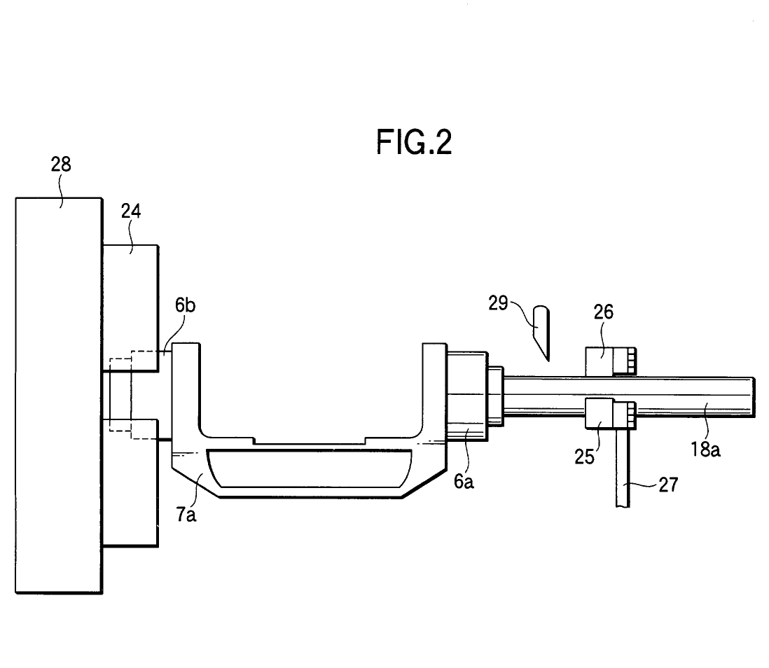

The trunnion 7a and rod 18a constituting a toroidal-type continuously variable transmission according to the present invention are formed as an integral body by finish working single blank material which has been made by forging or by casting. That is, by casting or forging an iron-system alloy, there is made blank material having a dimension slightly larger than the dimension of the trunnion 7a and rod 18a after finished as well as a shape approximate to the trunnion 7a and rod 18a after finished. After then, a necessary finishing operation such as a cutting operation is enforced on the blank material to thereby produce such mutually integrated trunnion 7a and rod 18a as shown in FIG. 1. In the finishing operation, in case where the rod 18a and the outer peripheral surface of a pivot shaft 6a formed in one end portion (in FIG. 1, the lower end portion; in FIG. 2, the right end portion) of the integrated rod 18a and trunnion 7a is worked with the outer peripheral surface of a pivot shaft 6b formed in the other end portion (in FIG. 1, the upper end portion; in FIG. 2, the left end portion) of the trunnion 7a as the standard thereof, the axes of the two pivot shafts 6a, 6b can be made to coincide strictly with the axis of the rod 18a.

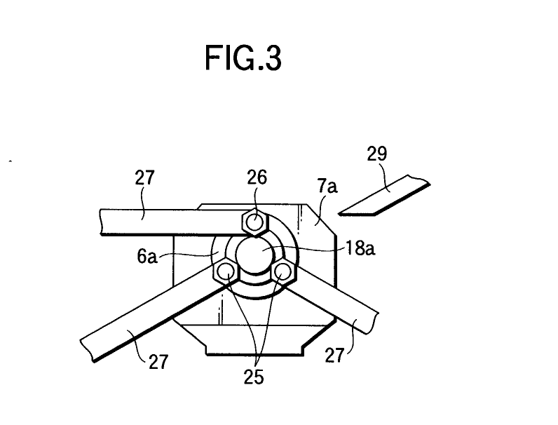

That is, after a finishing operation is enforced on the outer peripheral surface of the pivot shaft 6b on the above-mentioned other end portion side, the pivot shaft 6b is held by and fixed to (clamped to) a chuck 24 of a finish working apparatus such as a lathe. In this state, the pivot shaft 6b is supported so as to be concentric with a main spindle 28 having the chuck 24. Also, the rod 18a is supported by two receive rollers 25, 25 and a hold roller 26. These rollers 25, 26 are respectively supported on the leading end portions of their associated support arms 27, 27 so as to be rotated about axes respectively parallel to the axis of the main spindle 28. Also, the centers of the inscribed circles of the respective rollers 25, 26 lie on the axis of the main spindle 28. Therefore, in case where, while the trunnion 7a and rod 18a are supported in such a manner as shown in FIGS. 2 and 3, a cutting tool 29 is butted against the rod 18a and the outer peripheral surface of the pivot shaft 6a on the above-mentioned one end portion side. Then, while rotating the main spindle 28, the present outer peripheral surface is cut, the axis of the present outer peripheral surface can be made to coincide with the axis of the outer peripheral surface of the pivot shaft 6b on the above-mentioned other end portion side.

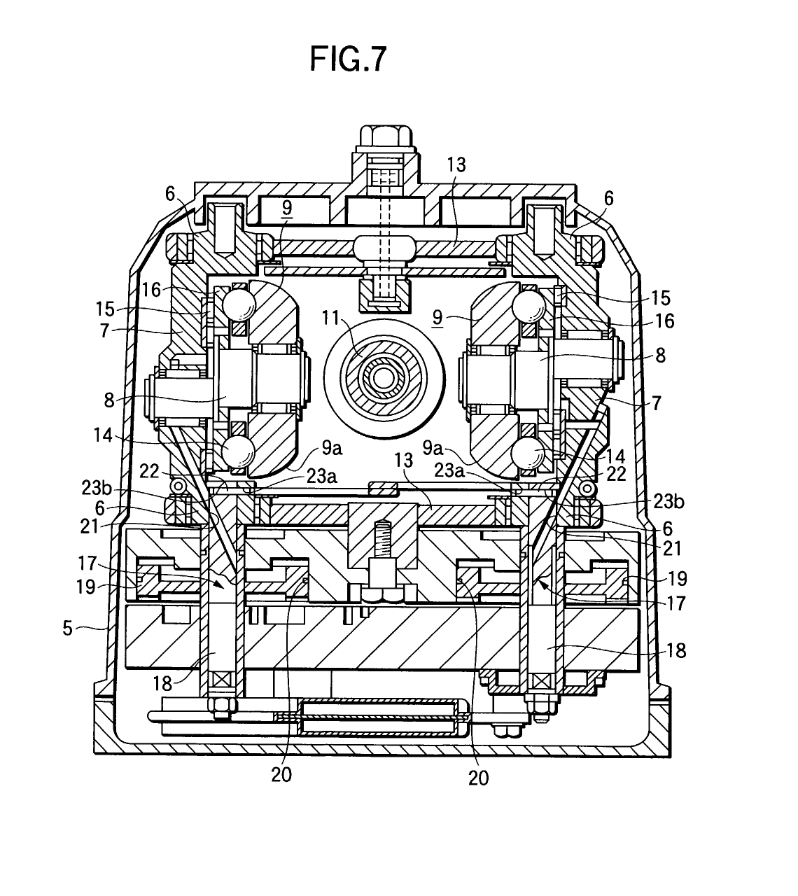

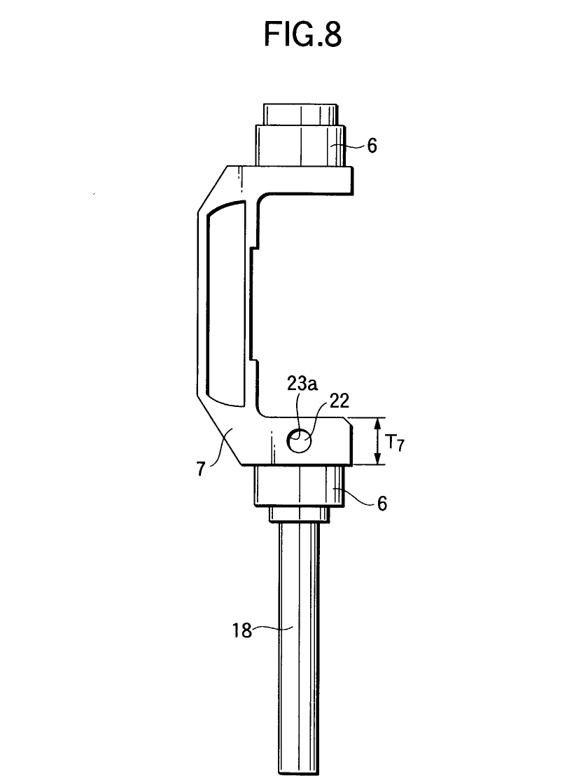

In the case of a toroidal-type continuously variable transmission according to the present embodiment incorporating therein the above-mentioned mutually integrated trunnion 7a and rod 18a, the manufacturing cost of the toroidal-type continuously variable transmission can be reduced, the size and weight thereof can be reduced, and the transmission operation thereof can be stabilized. That is, according to the present invention, since the trunnion 7a and rod 18a are formed as an integrated body from the beginning. When compared with the conventional structure shown in FIGS. 7 and 8, there is eliminated the operation to connect together the trunnion 7 and rod 18 which are produced separately from each other. Specifically, there are eliminated not only the operation to work the one end portion of the trunnion 7 to thereby form the connecting hole 21 therein but also the operation to insert the rod 18 into the connecting hole 21. Also, there is eliminated the operation to work the one-end portion of the trunnion 7 and the base end portion of the rod 18 to thereby form the pin holes 23a, 23b therein. At the same time, there is avoided the need for provision of the pin 22, which can eliminate the operation to insert the pin 22. This can facilitate the reduction of the manufacturing cost of the toroidal-type continuously variable transmission. At the same time, there is avoided a possibility that the trunnion 7 and rod 18 can be separated from each other due to removal of the pin 22, which can reduce the sources of trouble accordingly.

Also, as shown in FIGS. 1 and 2, since there is no need to work the one end portion of the trunnion 7a to thereby form the pin hole 23a (FIGS. 7 and 8) therein, there can be reduced the thickness of the trunnion 7a corresponding to the pin 22 (FIGS. 7 and 8) as well as the thickness of the trunnion 7a necessary to secure the strength of the periphery of the pin hole 23a that is necessary when the pin 22 is pressure inserted. This can facilitate the reduction of the size and weight of the toroidal-type continuously variable transmission. That is, as can be understood clearly when FIGS. 1 and 2 are compared with FIG. 8, according to the structure of the present invention, the thickness T₇ₐ of the one-end portion of the trunnion 7a can be reduced over the thickness T₇ employed in the conventional structure (T₇ₐ<T₇). Thus the axial-direction dimension of the trunnion 7a can be shortened by an amount corresponding to the difference (|T₇−T₇ₐ|), which makes it possible to reduce the size and weight of the toroidal-type continuously variable transmission accordingly.

Also, since the axes of the pivot shafts 6a, 6b disposed on the two end portions of the trunnion 7a can be easily made to coincide with the axis of the rod 18a disposed on the one end portion of the trunnion 7a, the transmission operation of the toroidal-type continuously variable transmission can be stabilized. That is, when the toroidal-type continuously variable transmission is in operation, as the trunnion 7a is swung, the rod 18a is rotated; and, in this case, the swinging motion of the rod 18a can be controlled to a slight level if it occurs. This can prevent an excessive increase in the frictional force that acts on between the outer peripheral surface of the piston 19 fixed to the middle portion of the rod 18a and the inner peripheral surface (FIG. 7) of the cylinder 20 with the piston 19 fitted thereinto. Thus, the frictional force can be reduced and the piston 19 can be operated smoothly. Therefore, a plurality of trunnions 7a forming the toroidal-type continuously variable transmission can be swung and shifted more uniformly, which makes it possible to stabilize the transmission operation of the toroidal-type continuously variable transmission.

Further, the variations in the distance between the portions of the respective trunnions 7a for supporting the power rollers 9 (FIGS. 4 to 7) and the remaining portions of the trunnions 7a, which are conventionally caused by the manufacturing errors and assembling errors, are made difficult to occur. This can also stabilize the transmission operation of the toroidal-type continuously variable transmission. That is, as in a case where, as shown in FIGS. 7 and 8, the separately produced trunnion 7 and rod 18 are connected and fixed together, when two different and separate parts are connected together, there can occur errors. However, according to the present invention, there is no possibility that such errors can occur and, therefore, the distance between the power roller 9 supporting portion and the piston 19 fixing portion or the precess cam (not shown) fixing portion can be restricted strictly to the designed value with ease. Thanks to this, the transmission operation of the toroidal-type continuously variable transmission can be stabilized without increasing the manufacturing cost thereof excessively.

Since the present invention is structured and operates in such a manner as described above, there can be realized a toroidal-type continuously variable transmission at a low cost which not only can be structured so as to be small in size and light in weight but also is able to execute a stable transmission operation.

What is claimed is:

1. A toroidal-type continuously variable transmission, comprising:
an input side disk;
an output side disk disposed concentric with the input side disk;
a plurality of trunnions interposed between the input side disk and the output side disk and swingable about pivot shafts situated at twisted positions with respect to the axes of the input side and output side disks;
a plurality of displacement shafts disposed on the trunnions one by one so as to project from inner surfaces of respective trunnions;
a plurality of power rollers disposed on the trunnions one by one and held between inner surfaces of the input side and output side disks so as to be rotatably supported on respective displacement shafts;
a plurality of rods having respective base end portions connected and fixed to one-end portions of the trunnions, the rods being disposed concentric with the pivot shafts of the trunnions; and,
a plurality of actuators for shifting the rods in the axial direction thereof,
wherein the trunnion and the rod are integrally formed of a single material.

2. The toroidal-type continuously variable transmission as set forth in claim 1, wherein the trunnion and the rod are integrally formed of the single material by forging or by casting.

3. The toroidal-type continuously variable transmission as set forth in claim 1, wherein the trunnion and the rod are produced by finish working an integral body, after forming the integral body of an iron-system alloy by forging or casting

4. The toroidal-type continuously variable transmission as set forth in claim 3, wherein the finish working includes cutting.

5. The toroidal-type continuously variable transmission as set forth in claim 3, wherein the outer peripheral surfaces of the rod and the pivot shafts formed in the one-end portions of the trunnions are worked with the outer peripheral surfaces of the pivot shafts formed in the-other-end portions of the trunnions as the standards.
